(19) United States
(12) Patent Application Publication
(10) Pub. No.: US 2007/0247752 A1
(43) Pub. Date: Oct. 25, 2007

(54) Perpendicular magnetic head

(75) Inventors: Mitsuru Otagiri, Kawasaki (JP); Yuko Miyake, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 11/485,494

(22) Filed: Jul. 12, 2006

(30) Foreign Application Priority Data
Apr. 21, 2006 (JP) 2006-118121

(51) Int. Cl. G11B 5/147

(52) U.S. Cl. 360/126

(57) ABSTRACT

A perpendicular magnetic head suppresses pole erasing due to a remanent magnetization component of a main pole and is capable of higher density recording. The perpendicular magnetic head is equipped with a main pole that produces magnetic flux toward a medium surface of a recording medium as a write head. The main pole is formed by laminating two thin magnetic layers in the thickness direction. Out of the thin magnetic films, a top thin magnetic film is formed as a high Bs thin magnetic film with a first saturation flux density and a bottom thin magnetic film is formed as a low Bs thin magnetic film with a second saturation flux density that is lower than the first saturation flux density, and the high Bs thin magnetic film and the low Bs thin magnetic film satisfy the following equation

(volume of the high Bs thin magnetic film)×(first saturation flux density)<(volume of the low Bs thin magnetic film)×(second saturation flux density).

### BACKGROUND OF THE INVENTION

1. Field of the Invention

The present invention relates to a perpendicular magnetic head, and in more detail to a perpendicular magnetic head characterized by the construction of a main pole of a recording head.

2. Related Art

FIG. 6 shows one example of the construction of a perpendicular magnetic head used in a magnetic disk apparatus. This perpendicular magnetic head is made up of a read head 8 provided at a position where a reproduction MR element 6 is sandwiched between a lower shield layer 5 and an upper shield layer 7, and a write head 10 equipped with a main pole 12 and a return yoke 15 disposed on opposite sides of a write gap 13. On an end portion of a return yoke 15, a trailing shield 14 that prevents a magnetic field produced from the main pole 12 from spreading to the return yoke 15 is provided, and a recording coil 11 is disposed between the return yoke 15 and the main pole 12.

In a magnetic disk apparatus, as the recording density has increased, materials with higher coercive forces have come to be used for the recording medium. The write head of the magnetic head therefore needs to produce a strong magnetic field to write information on tracks that have become narrower. For this reason, a magnetic material with a high saturation flux density (a high Bs value) is used for the write head of a perpendicular magnetic head and in particular for the main pole of the write head.

However, since materials with a high Bs value usually have poor soft magnetic characteristics and a large remanent magnetization component, a so-called “pole erasing” problem occurs whereby information recorded on the recording medium is deleted by a magnetic field produced from the main pole even when a current is not flowing in the recording coil.

For this reason, methods have been proposed where as shown in FIG. 5A, a pole end 12a of the main pole 12 is produced in an inverted trapezoidal form (a shape where the trailing shield 14 side is wide and the write head side is narrow) to prevent the effects of remanent magnetization on adjacent tracks when the magnetic head performs a seek operation between the inner periphery and the outer periphery of the medium, where as shown in FIG. 5B, magnetic flux is concentrated in a pole end 12a produced by narrowly extending the front end of the main pole 12, and where the end surface form of the main pole 12 is formed as a “T” shape or the like (see Patent Document 1).

### Patent Document 1

Japanese Laid-Open Patent Publication No. 2003-242608

However, with methods that merely modify the shape of the main pole, in reality it is still difficult to solve the problem of pole erasing by the remanent magnetization component produced due to a high Bs material being used for the main pole, and conventionally the main pole 12 is formed using a magnetic material with as high a saturation flux density as possible within a range where the pole erasing problem does not occur.

### SUMMARY OF THE INVENTION

The present invention was conceived to solve the above problems with conventional perpendicular magnetic heads, and it is an object of the present invention to provide a perpendicular magnetic head where the construction of the main pole of the perpendicular magnetic head is improved so that the problem of pole erasing due to a remanent magnetization component of the main pole is solved and a magnetic material with a high saturation flux density can be used for the main pole, thereby making high density recording possible.

To achieve the object stated above, a perpendicular magnetic head according to the present invention is equipped with a main pole that produces magnetic flux toward a medium surface of a recording medium as a write head, wherein the main pole is formed by laminating two thin magnetic layers in a thickness direction of the main pole, and out of the thin magnetic films, a top thin magnetic film is formed as a high Bs thin magnetic film with a first saturation flux density, a bottom thin magnetic film is formed as a low Bs thin magnetic film with a second saturation flux density that is lower than the first saturation flux density, and the high Bs thin magnetic film and the low Bs thin magnetic film satisfy the following equation

(volume of the high Bs thin magnetic film)×(first saturation flux density)<(volume of the low Bs thin magnetic film)×(second saturation flux density).

In addition, by forming the main pole so that an end surface of a pole end has an inverse trapezoidal form, it is possible to further suppress a pole erasing action caused by a remanent magnetization component of the main pole.

The main pole may be formed with an inverse trapezoidal cross-sectional form, and when a length of a bottom edge of an end surface of a pole end of the main pole is expressed as “a”, a length of a top edge as “c”, a length of the bottom edge of the high Bs thin magnetic film as “b”, a height of the high Bs thin magnetic film as “T_h”, a saturation flux density of the high Bs thin magnetic film as “Bs_h”, a height of the low Bs thin magnetic film as “T_{—}1”, and a saturation flux density of the low Bs thin magnetic film as “Bs_{—}1”, the high Bs thin magnetic film and the low Bs thin magnetic film may satisfy the following equation

T_{—}h×(c+b)×Bs_{—}h<T_{—}1(b+a)×Bs_{—}1.

In this way, when the main pole is formed with a trapezoidal cross-sectional form, it is possible to design the high Bs thin magnetic film and the low Bs thin magnetic film based on the end surface form of the pole end of the main pole.

Also, by forming the low Bs thin magnetic film using a magnetic material with a coercive force in the axis of difficult magnetization (Hc) of 50e or below, it is possible to effectively suppress the pole erasing effect due to the remanent magnetization component caused by the main pole including the high Bs thin magnetic film.

By forming the main pole with a laminated construction composed of a high Bs thin magnetic film and a low Bs thin magnetic film that has superior soft magnetic characteristics, the perpendicular magnetic head according to the present invention is capable of recording information with a high density on a recording medium due to the action of the high Bs thin magnetic film. The action of the low Bs thin magnetic film also makes it possible to suppress the remanent magnetization component caused by the high Bs thin magnetic film. This means it is possible to realize the object of writing information at high density using the main pole and also the object of preventing pole erasing.

### BRIEF DESCRIPTION OF THE DRAWINGS

The aforementioned and other objects and advantages of the present invention will become apparent to those skilled in the art upon reading and understanding the following detailed description with reference to the accompanying drawings.

In the drawings:

FIGS. 1A and 1B are diagrams useful in explaining a construction of a main pole of a write head;

FIG. 2 is a diagram useful in explaining an example design of a magnetic pole;

FIG. 3 is a diagram showing a magnetic field that acts from the main pole onto a recording medium;

FIGS. 4A to 4C are diagrams useful in explaining a method of manufacturing the main pole;

FIG. 5A is a view showing the end surface of a main pole and FIG. 5B a plan view; and

FIG. 6 is a cross-sectional view showing the construction of a perpendicular magnetic head.

### DESCRIPTION OF THE PREFERRED EMBODIMENT

A preferred embodiment of the present invention will now be described with reference to the attached drawings.

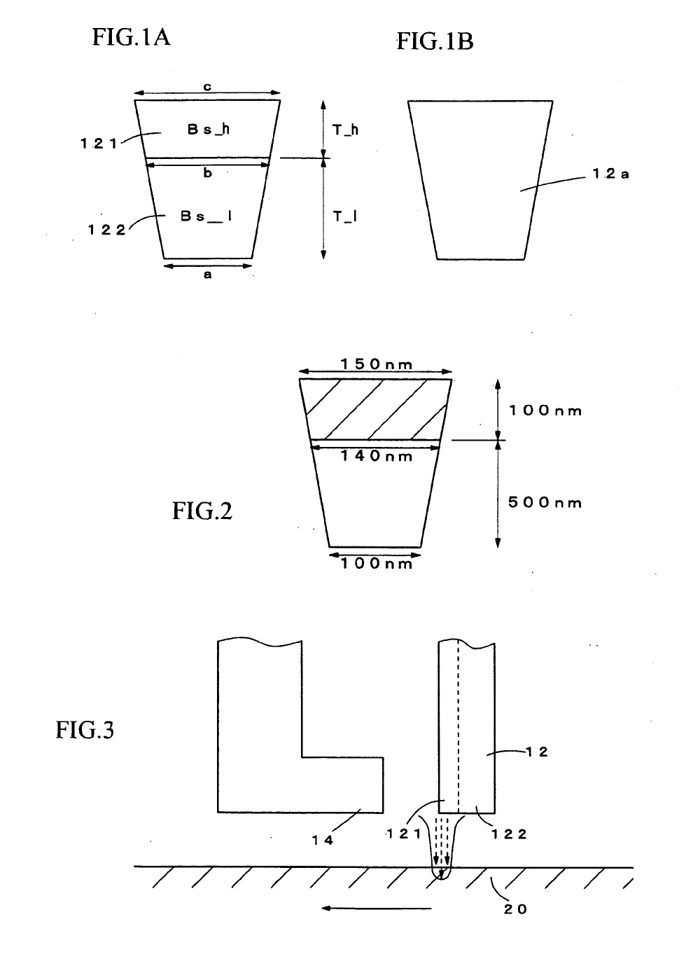

A perpendicular magnetic head according to the present invention is characterized by the main pole of the write head having a two-layer construction composed of a high Bs material and a low Bs material. FIG. 1A shows the main pole of a perpendicular magnetic head according to the present invention when looking toward an end of the pole. FIG. 1B shows the main pole of a conventional perpendicular magnetic head as a comparative example.

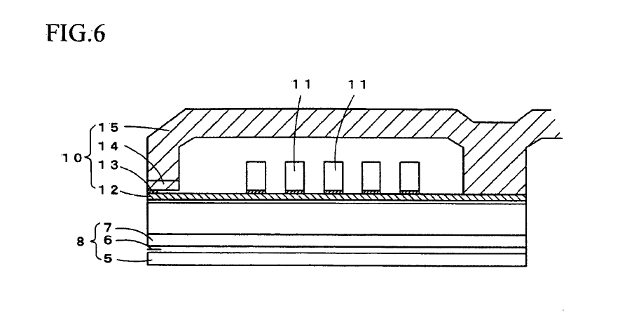

Although an example where the present invention has been adapted to the main pole 12 of the perpendicular magnetic head shown in FIG. 6 will now be described, the perpendicular magnetic head may have various different constructions. The present invention can also be applied to such various perpendicular magnetic heads. Note that since the construction of the perpendicular magnetic head shown in FIG. 6 has been described above, further description thereof has been omitted. The pole end 12a of the main pole shown in FIG. 1A is shown in a state when looking toward the pole end 12a of the main pole 12 in FIG. 6.

As shown in FIG. 1B, the main pole used in the write head of the conventional perpendicular magnetic head is formed so that the end surface form of the pole end 12a is produced in an inverted trapezoidal form where the side that faces the trailing shield 14 is wider than the write head side. This main pole is formed of a thin magnetic film with a high saturation flux density such as FeCo, and is formed as a single film.

As shown in FIG. 1A, although the end surface form of the pole end 12a is produced with an inverted trapezoidal form in the same way as the conventional example, the main pole 12 of the write head of the perpendicular magnetic head according to the present invention is characterized by being formed of two layers composed of different magnetic materials in the thickness direction of the main pole 12. The side facing the trailing shield 14 (the top thin magnetic film) is formed as a high Bs thin magnetic film 121 composed of a high Bs material and a right head side (the bottom thin magnetic film) is formed as a low Bs thin magnetic film 122 composed of a low Bs material.

To make it possible for the write head 10 to write with high precision, the high Bs thin magnetic film 121 provided on the side of the main pole 12 that faces the trailing shield 14 is formed using a magnetic material such as Fe₆₀Co₄₀ with a sufficiently high saturation magnetic flux density. The magnetic material that forms the high Bs thin magnetic film 121 is selected with the production of a strong magnetic field having primary importance.

On the other hand, the low Bs thin magnetic film 122 is provided to suppress the remanent magnetization component of the main pole 12, and therefore a magnetic material is selected with soft magnetic characteristics having primary importance. As one example, nickel iron (NiFe) alloys are materials with superior soft magnetic characteristics. A magnetic material with such superior soft magnetic characteristics is used for the low Bs thin magnetic film 122.

According to the present invention, the high Bs thin magnetic film 121 is disposed on the side of the main pole 12 that faces the trailing shield 14 because the action whereby the main pole 12 writes on the recording medium is produced by a magnetic field from close to the surface of the main pole 12 that faces the trailing shield 14.

FIG. 3 is a diagram useful in explaining the positional relationship between the main pole 12, the trailing shield 14, and a recording medium 20. When information is recorded on the recording medium 20 by the write head 10, magnetic flux is directed from the main pole 12 toward the recording medium 20, and as shown in FIG. 3, the intensity of the recording magnetic field produced by the main pole 12 is substantially localized in a region of the main pole 12 that faces the trailing shield 14 (shown by the curved lines in FIG. 3). Accordingly, to cause a strong magnetic field to act upon the recording medium 20, it is sufficient to use a high Bs material for the thin magnetic film at a part of the main pole 12 that faces the trailing shield 14.

On the other hand, if the entire main pole 12 were formed from only a high Bs material, there would be the problem of pole erasing due to the remanent magnetization component of the main pole 12 and therefore it is effective to use a magnetic material with superior soft magnetic characteristics in regions aside from the part of the main pole 12 that faces the trailing shield 14. For this reason, according to the present invention, the low Bs thin magnetic film 122 is used as the write head side of the main pole 12.

To counteract the remanent magnetization component from the main pole 12 when a current is not flowing through the recording coil 11, the action of the low Bs thin magnetic film 122 needs to be predominant. To do so, since the magnetic characteristics of the high Bs thin magnetic film 121 and the low Bs thin magnetic film 122 are believed to be reflected by the products of the respective volumes of the films in the main pole 12 and the respective saturation flux densities showing the magnetic characteristics of the films, the thicknesses and the like of the high Bs thin magnetic film 121 and the low Bs thin magnetic film 122 are determined so as to satisfy the following equation

(volume of the high Bs thin magnetic film)×(Bs value of the high Bs thin magnetic film)<(volume of the low Bs thin magnetic film)×(Bs value of the low Bs thin magnetic film).

In this way, if the magnetic component provided by the entire low Bs thin magnetic film 122 is made larger than the magnetic component provided by the entire high Bs thin magnetic film 121, when a current is not flowing through the recording coil, the entire main pole 12 is expressed by the soft magnetic characteristics due to the low Bs thin magnetic film 122.

Note that the expressions “the volume of the high Bs thin magnetic film” and “the volume of the low Bs thin magnetic film” here refer to the volumes at positions that contribute to the writing of information by the main pole 12 on the recording medium. Accordingly, as shown in FIG. 5B, when the main pole 12 is formed so as to project outward with an inverse trapezoidal cross-sectional form, the volumes of the films may be set by considering only the form of the end surface of the pole end 12a of the main pole 12.

Here, as shown in FIG. 1A, when a length of a bottom edge of the main pole 12 is expressed as “a”, a length of a top edge as “c”, a length of the bottom edge of the high Bs thin magnetic film 121 as “b”, a height (in the thickness direction of the main pole 12) of the high Bs thin magnetic film 121 as “T_h”, the saturation flux density of the high Bs thin magnetic film 121 as “Bs_h”, a height of the low Bs thin magnetic film 122 as “T_{—}1”, and the saturation flux density of the low Bs thin magnetic film 122 as “Bs_{—}1”, the thicknesses and the like of the high Bs thin magnetic film 121 and the low Bs thin magnetic film 122 should be decided so as to satisfy the following equation.

T_{—}h×(c+b)×Bs_{—}h<T_{—}1×(b+a)×Bs_{—}1

The equation given above shows that the high Bs thin magnetic film 121 and the low Bs thin magnetic film 122 are decided according to only the end surface form of the main pole 12.

Note that actual experiments were carried out to find out the approximate level of coercive force of the thin magnetic films forming the main pole 12 at which pole erasing occurs. The relative merits of the soft magnetic characteristics were compared in general using the coercive force in the axis of difficult magnetization (Hc). According to such experiments, pole erasing occurred when the main pole was formed as a single film of Fe₆₀Co₄₀ where Hc is around 100e, but pole erasing did not occur when the main pole was formed as a single film of Ni₁₀Fe₉₀ where Hc is around 50e. From this evidence, it is possible to regard magnetic materials where Hc is around 50e or below as having superior soft magnetic characteristics and it is therefore effective to use a magnetic material where Hc is around 50e or below as the low Bs thin magnetic film 122 according to the present invention.

FIG. 2 shows an example design of a perpendicular magnetic head according to the present invention. Fe₆₀Co₄₀ is used as the high Bs thin magnetic film 121 and Ni₈₀Fe₂₀ is used as the low Bs thin magnetic film 122. For Fe₆₀Co₄₀, the saturation flux density is 2.4T and Hc is 150e, while for Ni80Fe20, the saturation flux density is 1.0T and Hc is 10e. Also, as shown in FIG. 2, a=90 nm, b=140 nm, c=150 nm, T_h=100 nm, and T_{—}1=500 nm.

Calculation for the high Bs thin magnetic film.

Bs_{—}h×T_{—}h×(c+b)=2.4×100×(150+140)=69600(T·nm²)

Calculation for the low Bs thin magnetic film.

Bs_{—}1×T_{—}1×(b+a)=1.0×500×(149+90)=115000(T·nm²)

These calculation results satisfy the equation T_h×(c+b)×Bs_h<T_{—}1(b+a)×Bs_{—}1 given above.

That is, with the example construction of the main pole 12 shown in FIG. 2, by disposing the high Bs thin magnetic film 121 in a region of the main pole 12 that faces the trailing shield 14, when a current is passed through the recording coil 11 to record information, it is possible to make use of the characteristics of the high Bs thin magnetic film 121 and carry out high density writes. Conversely, when a current is not passed through the recording coil 11, the soft magnetic characteristics of the low Bs thin magnetic film 122 become predominant, making it possible to suppress the remanent magnetization component caused by the high Bs thin magnetic film 121. By doing so, it is possible to eradicate pole erasing due to the remanent magnetization component caused by the high Bs thin magnetic film 121.

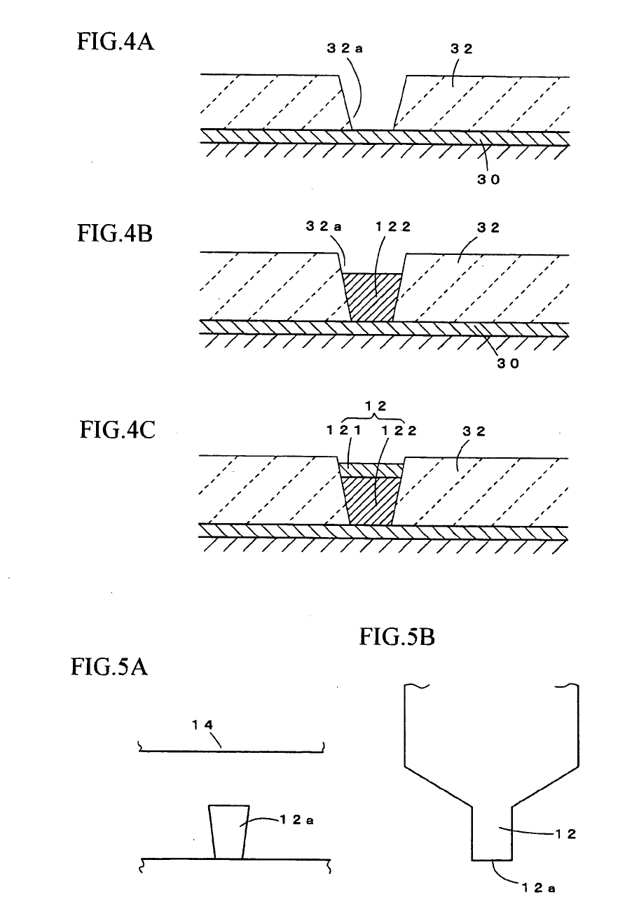

As a method of forming a main pole 12 such as that shown in FIGS. 1A and 2 with a two-layer construction composed of the high Bs thin magnetic film 121 and the low Bs thin magnetic film 122, as shown in FIGS. 4A to 4C, after a base layer 30 of the main pole 12 has been formed on the surface of a workpiece (a wafer), the base layer 30 is coated with a resist 32, and then exposing and developing are carried out in accordance with a formation pattern of the main pole 12 to form a concave channel 32a at a position where the main pole 12 is to be formed. FIG. 4A shows the state where the concave channel 32a is viewed in a direction where an end surface of the main pole 12 is visible. The concave channel 32a is formed in an inverse trapezoidal form where the bottom is narrow and the opening is wide so that the end surface of the main pole 12 has an inverse trapezoidal form.

FIG. 4B shows a state where the low Bs thin magnetic film 122 that composes the main pole 12 has been formed inside the concave channel 32a. The low Bs thin magnetic film 122 can be formed by plating or sputtering on the bottom of the concave channel 32a with a predetermined thickness.

FIG. 4C shows a state where the high Bs thin magnetic film 121 has next been formed inside the concave channel 32a so as to be laminated on the low Bs thin magnetic film 122. The high Bs thin magnetic film 121 can also be formed by plating or sputtering with a predetermined thickness.

As shown in FIG. 4C, after the high Bs thin magnetic film 121 has been laminated on the low Bs thin magnetic film 122, by lifting off the resist 32, the main pole 12 which is composed of the low Bs thin magnetic film 122 and the high Bs thin magnetic film 121 formed on top of each other and whose pole end 12a is formed in an inverse trapezoidal form is left in a pattern on the surface of the workpiece.

In this way, the main pole 12 can be formed using a conventional process that forms a layer by patterning a resist. It is possible to decide the end surface form of the concave channel 32a in accordance with the end surface form of the main pole 12, and the main pole 12 can be formed with a desired form by controlling the thicknesses of the low Bs thin magnetic film 122 and the high Bs thin magnetic film 121.

Next, the write head 10 is formed by successively forming the write gap 13, the coil 11, and the return yoke 15.

What is claimed is:

1. A perpendicular magnetic head equipped with a main pole that produces magnetic flux toward a medium surface of a recording medium as a write head,
wherein the main pole is formed by laminating two thin magnetic layers in a thickness direction of the main pole, and
out of the thin magnetic films, a top thin magnetic film is formed as a high Bs thin magnetic film with a first saturation flux density, a bottom thin magnetic film is formed as a low Bs thin magnetic film with a second saturation flux density that is lower than the first saturation flux density, and the high Bs thin magnetic film and the low Bs thin magnetic film satisfy the following equation
(volume of the high Bs thin magnetic film)×(first saturation flux density)<(volume of the low Bs thin magnetic film)×(second saturation flux density).

2. A perpendicular magnetic head according to claim 1, wherein the main pole is formed so that an end surface of a pole end has an inverse trapezoidal form.

3. A perpendicular magnetic head according to claim 2, wherein the main pole is formed with an inverse trapezoidal cross-sectional form, and when a length of a bottom edge of an end surface of a pole end of the main pole is expressed as “a”, a length of a top edge as “c”, a length of the bottom edge of the high Bs thin magnetic film as “b”, a height of the high Bs thin magnetic film as “T_h”, a saturation flux density of the high Bs thin magnetic film as “Bs_h”, a height of the low Bs thin magnetic film as “T_{—}1”, and a saturation flux density of the low Bs thin magnetic film as “Bs_{—}1”, the high Bs thin magnetic film and the low Bs thin magnetic film satisfy the following equation
T_{—}h×(c+b)×Bs_{—}h<T_{—}1×(b+a)×Bs_{—}1.

4. A perpendicular magnetic head according to claim 1, wherein the low Bs thin magnetic film is composed of a magnetic material with a coercive force in the hard axis (Hc) of 50e or below.

5. A perpendicular magnetic head according to claim 2, wherein the low Bs thin magnetic film is composed of a magnetic material with a coercive force in the hard axis (Hc) of 50e or below.

6. A perpendicular magnetic head according to claim 3, wherein the low Bs thin magnetic film is composed of a magnetic material with a coercive force in the hard axis (Hc) of 50e or below.
